(19) United States
(12) Patent Application Publication
(10) Pub. No.: US 2007/0057198 A1
(43) Pub. Date: Mar. 15, 2007

(54) Apparatus for and method of measuring flourescence lifetime

(76) Inventors: Tony Wilson, Oxford (GB); Martin Booth, Oxford (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/564,342

(22) PCT Filed: Jul. 15, 2004
(86) PCT No.: PCT/GB04/03068

§ 371 Date: Jul. 24, 2006

(30) Foreign Application Priority Data
Jul. 17, 2003 (GB) 0316736.8

(51) Int. Cl. G01N 21/64

(52) U.S. Cl. 250/458.1

(57) ABSTRACT

A method of measuring fluorescence lifetime includes illuminating a sample containing at least one fluorophore with light to excite fluorescence and switching the intensity of the excitation light repeatedly between a first intensity I₁ and a second intensity 1₂. Emitted light caused by fluorescence of the sample is detected and a detected light signal is generated. The detected light signal is switched repeatedly to divide it into first and second portions, and the amount of light detected during each of the first and second portions is measured to obtain a first emitted light value S₁ and a second emitted light value S₂. The fluorescence lifetime is determined from the first and second emitted light values S₁ and S₂.

The present invention relates to an apparatus for and a method of measuring fluorescence lifetime. The invention is suitable for various fluorescence lifetime measurement applications, including in particular, but not exclusively, fluorescence lifetime imaging measurement (FLIM) and fluorescence assays. The invention is also suitable, for example, for DNA sequencing, protein sequencing and for semiconductor material characterisation by photoluminescence. The present invention also provides a method and a system for identifying labelled objects, in particular security marked objects, by detecting the fluorescence lifetimes of fluorescent materials contained in labels carried by the objects.

The measurement of fluorescence lifetime is becoming increasingly important since the fluorescence lifetime of a fluorophore depends on and thus provides an indication of certain characteristics of the physical or chemical environment, e.g. pH, viscosity etc. The fluorescence lifetime is also often used as an additional contrast mechanism in microscopy where its lack of dependence on the absolute value of fluorescence intensity is important. It is also important in FRET (F o̅rster resonant energy transfer) studies to have an accurate knowledge of the fluorescence lifetime. More recently, and of potential commercial importance, it has been found useful in assay applications, for example in DNA sequencing.

There are two broad approaches to the measurement of fluorescence lifetime. One approach is to use an ultra-short laser pulse to excite the fluorescence. The lifetime or lifetimes are then inferred from the subsequent temporal decay of the emitted fluorescence. The drawbacks to this approach are:
(i) The need for a suitable short-pulse laser. In order to measure lifetimes in the range 1-10 ns, which are typical values for biologically relevant fluorophores, pulse widths less than 100 ps are required. This requirement is met, for example, by expensive Ti:Sapphire or Nd:glass lasers. These would typically be used for two-photon excitation fluorescence. Alternatively, cheaper semi-conductor lasers are available but these are not so bright.
(ii) The measurement of the temporal fluorescence decay usually requires the use of expensive time correlated single photon counting (TCSPC) techniques.

The second approach to the measurement of fluorescence lifetime is to modulate harmonically the intensity of the illumination and to infer the lifetime from the relative phase shift (and modulation) between the excitation illumination and the detected fluorescence signal. The major drawbacks to this approach are:
(i) It is necessary to modulate the illumination, ideally sinusoidally, at MHz frequencies to achieve reasonable values of phase shift for typical lifetimes.
(ii) It is difficult to extract multiple lifetime data.
(iii) The demodulation electronics are complicated by the requirement to provide phase modulation information over a wide range of frequencies.

It is an object of the present invention to provide an apparatus for and a method of measuring fluorescence lifetime, which mitigates at least some of the aforesaid disadvantages.

According to the present invention, there is provided a method of measuring fluorescence lifetime, the method including illuminating a sample containing at-least one fluorophore with light to excite fluorescence, switching the intensity of the excitation light repeatedly between a first intensity I₁ and a second intensity I₂, detecting emitted light caused by fluorescence of the sample and generating a detected light signal, repeatedly switching the detected light signal to divide it into first and second portions, measuring the amount of light detected during each of said first and second portions to obtain a first emitted light value S₁ and a second emitted light value S₂, and determining the fluorescence lifetime from the first and second emitted light values S₁, and S₂.

The method allows the fluorescence lifetime of a fluorophore to be determined rapidly and accurately. The need for very expensive equipment such as a short pulse laser is avoided. It is not necessary to modulate the intensity of the light source sinusoidally. A simple and inexpensive switched light source such as a diode laser can thus be used. The control circuits and the detection circuits can be very simple and may for example be implemented using simple digital logic circuits. Because the detector operates continuously all the detected light is used. Further, a much lower intensity light source may be used, which avoids the risk of “bleaching” photo-sensitive samples.

The second intensity I₂ may be substantially zero. In other words, the excitation light may simply be switched on and off.

Advantageously, the excitation light is switched at a first frequency F₁ and the detected light signal is switched at a second frequency F_{D} where F_{D} is related to F₁. F_{D} is preferably synchronised with FT and may be equal to F_{I} or a hannonic of F_{I}.

The excitation light is advantageously switched at a frequency that lies in the range 1-1000 MHz, preferably 10-100 MHz. Higher and lower switching frequencies are however also possible.

In a preferred method for determining the fluorescence lifetimes of two different fluorophores, the detected light signal is switched at a first frequency F_{D} to obtain a first set of emitted light values S₁ and S₂ from which a first fluorescence lifetime is determined, and the detected light signal is then switched at a second frequency F_{D}′ to obtain a second set of emitted light values S₁′ and S₂′ from which a second fluorescence lifetime is determined. F_{D} and F_{D}′ are preferably harmonics of the excitation light switching frequency F_{I} (one of which may be equal to F₁). This allows the fluorescence lifetimes of two different fluorophores to be determined.

The excitation light may be switched according to a switching function that includes a plurality of components of different frequencies. For example, the switching function may include a first component F₁ and a second component F₁′ that is a harmonic of F₁. For example, the function may comprise a first frequency F and a second frequency 10F. The basic shape of the switching function is preferably a square wave.

The intensity of the excitation light may alternatively be switched repeatedly between a first intensity I₁, a second intermediate intensity I₂ and a third intensity I₃, which is preferably substantially zero.

According to another aspect of the invention there is provided an apparatus for measuring the fluorescence lifetime of a sample containing at least one fluorophore, the apparatus including a light source for illuminating the sample with light to excite fluorescence, first switching means for switching the intensity of the excitation light repeatedly between a first intensity I₁ and a second intensity I₂, a detector for detecting emitted light caused by fluorescence of the sample and generating a detected light signal, second switching means for dividing the detected light signal into first and second portions, means for measuring the amount of light detected during said first and second portions to obtain a first emitted light value S₁ and a second emitted light value S₂, and means for determining the fluorescence lifetime from the first and second emitted light values S₁ and S₂.

The apparatus may include control means for controlling switching of the first switching means and the second switching means.

The first switching means may be connected to the light source for controlling the intensity of the light generated by the light source. Alternatively, the first switching means may be connected to a modulator device for controlling the intensity of the excitation light incident on the sample. The modulator device is preferably a mechanical shutter or more preferably an electro-optical or a cousto-optical shutter.

The light source may be a diode laser or it may for example comprise one or more light emitting diodes (LEDs). Other light sources may also be suitable.

The apparatus may comprise part of a microscopic imaging system, which may for example include a confocal scanning microscope. Alternatively, the apparatus may comprise part of a fluorescence assay system. The fluorescence assay system may include a plurality of sample holders, the apparatus including a plurality of detectors and means for measuring the fluorescence lifetimes of samples in the sample holders substantially simultaneously.

The apparatus is preferably constructed and arranged to operate according to a method as defined by one of the preceding statements of invention.

Many fluorescence lifetime applications (e.g. imaging, where contrast is important) do not require detailed quantitative lifetime information such as that given by TCSPC or multiple frequency phase fluorimetry. Indeed the equivalent of one measurement at one frequency may suffice. However, at the moment, there is no simple inexpensive way to achieve this.

The present invention provides inter alia a method of measuring fluorescence lifetime, consisting of simple steps that may be implemented via fast analogs switching and low pass filtering. All the signal processing involved may be realised using inexpensive components. This readily permits many detection circuits to be implemented in parallel, which has direct application in lifetime based fluorescence assays. Present assays generally use the time domain approach with TCSPC boards and are limited to serial operation due to the expense of these components.

It is not necessary to use a laser light source. For example, fast switched LEDs may also be used, especially for non-imaging applications.

In prior art TCSPC systems where ultra-short pulsed diode laser or LED illumination is used, the average illumination power is low because of the low duty cycle. In the present approach the duty cycle is typically 50% and hence a higher average power is used. This means that more photons are detected per unit time than in the TCSPC case. Since the accuracy of any measurement is ultimately related to the number of detected photons, the present approach may be considered superior in this respect.

The switching periods required for a particular application can be chosen, according to the lifetimes of the fluorophores. The method thus permits a minimal implementation, as only the desired lifetimes are measured.

Since the approach provides rapid measurement of lifetimes, it is ideally suited for implementation in a scanning (confocal) microscope. It provides a low-cost alternative to commercial TCSPC systems. Indeed, for measurement of a single lifetime coefficient, the method is considerably quicker than TCSPC systems.

Another object of the invention is to provide a method and a system for identifying labelled objects, in particular security marked objects.

According to this aspect of the invention, there is provided a method of identifying labelled objects, wherein each object carries a label that contains a combination of fluorescent materials, the method including illuminating the label to excite fluorescence, detecting emitted light caused by fluorescence of the fluorescent materials, measuring the fluorescence lifetimes of the fluorescent materials, identifying from the fluorescence lifetimes the combination of fluorescent materials present in the label, and identifying the object from that combination.

The fluorescence lifetimes of the fluorescent materials are preferably measured using a method as described in the preceding statements of invention.

Advantageously, the method also includes measuring the wavelengths of the emitted light, and identifying the combination of fluorescent materials present in the label from the wavelengths and the fluorescence lifetimes. Preferably, it also includes measuring the intensity of the emitted light and identifying the combination of fluorescent materials present in the label from the wavelengths, the intensity and the fluorescence lifetimes.

Preferably, the label comprises an ink marking applied to the object, said ink including a combination of fluorescent materials.

According to a further aspect of the invention there is provided a system for identifying labelled objects, wherein each object carries a label that contains a combination of fluorescent materials and said combination identifies the object, the system including a light source for illuminating the label to excite fluorescence, a detector for detecting emitted light caused by fluorescence of the fluorescent materials, means for measuring the fluorescence lifetimes of the fluorescent materials, and a processor for identifying from the measured fluorescence lifetimes the combination of fluorescent materials present in the label, and for identifying the object from that combination.

The fluorescence lifetimes of the fluorescent materials are preferably measured using an apparatus as described in the preceding statements of invention.

Various embodiments of the invention will now be described, by way of example, with reference to the accompanying drawings, in which:

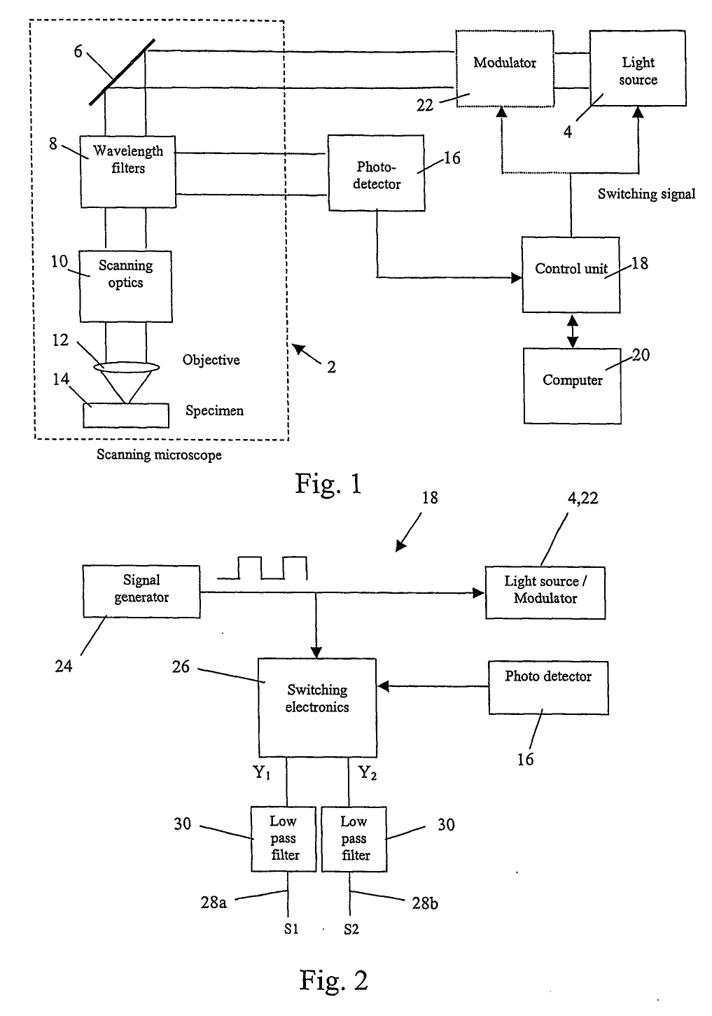

FIG. 1 is a schematic diagram of an apparatus for measuring fluorescence lifetime, implemented in a scanning microscope;

FIG. 2 is a schematic diagram of the detector electronics of the apparatus shown in FIG. 1;

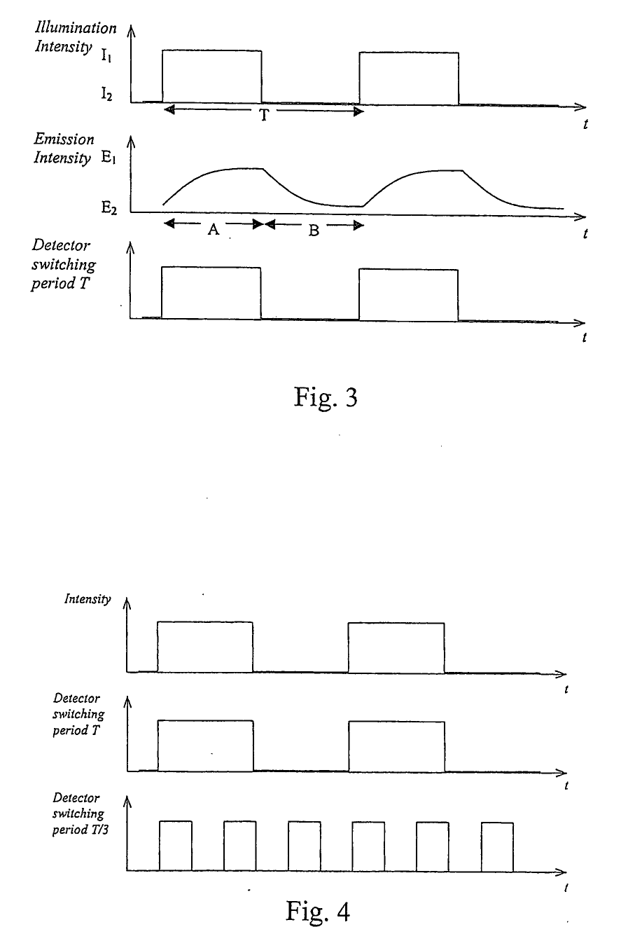

FIG. 3 is a set of graphs illustrating the relationship between the illumination intensity, the emission intensity and the detector switching period;

FIGS. 4, 5 and 6 are sets of graphs illustrating alternative relationships between the illumination intensity and the detector switching period; and

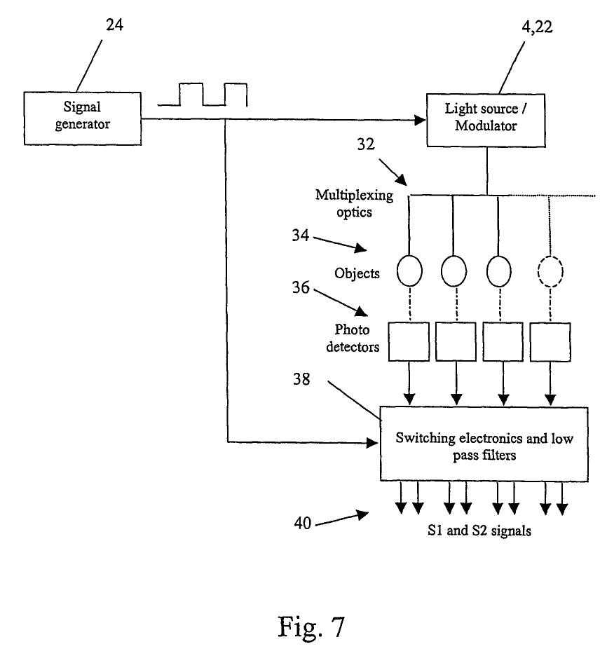

FIG. 7 is a schematic diagram of a second apparatus for measuring fluorescence lifetime, implemented in fluorescence assay equipment.

FIG. 1 is a schematic diagram of an apparatus for measuring fluorescence lifetime, implemented in a scanning microscope 2. The microscope 2 is of a conventional confocal design and includes a light source 4, a mirror 6, a set of wavelength filters 8, scanning optics 10 and an objective lens 12 for focusing light from the light source 4 onto a specimen 14. Light emitted from the specimen 14 is focused by the objective 12 and passes through the scanning optics 10, and is then reflected by the wavelength filters 8 onto the photodetector 16. The wavelength filters 8 may, for example, comprise a set of dichroic elements that transmit shorter wavelength light and reflect longer wavelength light (or vice versa, depending on the configuration). Excitation light from the light source 4 is therefore transmitted through the wavelength filters 8, whereas light emitted by fluorescence of the sample, which has a different wavelength, is reflected by the wavelength filters 8 towards the photodetector 16.

Various kinds of light source may be used, including for example diode lasers and LEDs. These may be designed to operate at visible, infrared or ultra violet wavelengths, according to the nature of the fluorophore being detected. The term “light”as used herein is intended to encompass visible, infrared and ultra violet wavelengths. Any suitable analogs or digital photodetector may be employed, including for example photomultipliers, photodiodes and charge coupled devices (CCDs). If the photodetector is a digital type (e.g. a single photon detector), simple digital electronic devices can be used to monitor the output.

The apparatus also includes an electronic control unit 18, which is connected to a computer 20. The control unit 18 is connected to the photodetector 16 and transmits output signals from the photodetector to the computer 20 for recording and analysis. The control unit 18 is also connected to the light source 4 to control operation of the light source. Alternatively, the control unit 18 may be connected to an optional modulator 22 located in front of the

light source 4, for modulating the intensity of the excitation light. Any suitable modulator 22 may be used including, for example, an electro-optical modulator or a mechanical shutter. If the light source 4 is one that can be modulated directly, for example a diode laser, the modulator 22 may not be required.

The components of the control unit 18 are shown schematically in FIG. 2. These include a signal generator 24 that generates a square wave output signal at a selected frequency. This signal is applied to the light source 4 or the optional modulator 22 to control the intensity of the excitation light. The control unit 18 also includes an electronic switching device 26 which receives an output signal from the photodetector 16 and the control signal from the signal generator 24, and switches the output signal alternately to two outputs 28a,b at a frequency determined by the signal generator 24, to provide two output signals S₁,S₂. Each of the outputs 28a,28b includes a low pass filter, to smooth output signals S₁,S₂.

The method of measuring the fluorescence lifetime of a sample will now be described with reference to FIG. 3, which shows the relationship between the illumination intensity I of the excitation light, the emission intensity B and the switching period T for the output of the photodetector 16.

The intensity I of the excitation light is switched alternately between the first level I, and a second level I₂ that is lower than I₁ and may, but need not necessarily, be zero. The switching period T is determined by the signal generator 24. Typically, the switching period is divided equally between the two intensity levels. The excitation light is therefore at the first level I₁ for a time T/2 and then at the second level I₂ for a time T/2. Alternatively, the switching period may be divided unequally between the two intensity levels.

When the excitation light is at the higher intensity level I₁, any fluorophores in the sample that are illuminated by the light will be excited and the emission intensity will therefore build towards a maximum value E₁. Subsequently, when the excitation light intensity falls to the lower level I₂, the emission intensity will decay to a minimum value E₂. This cycle is repeated continuously.

The photodetector 16 operates continuously, detecting all the emitted light that reaches it from the sample. The output of the photodetector 16 is however switched by the control unit 18 so that light detected during the first part of the cycle (A) while the excitation light

is at the higher intensity level I ₁, is directed to the first output 28a, whereas light emitted during the second part of the cycle (B), while the intensity of the excitation light is at the lower level I₂ is directed to the second output 28b. The control unit 18 therefore has two output signals, Y₁(t) and Y₂(t), which correspond to the intensity of the light detected during each half of the cycle. These output signals are smoothed by the low pass filters 30 to provide two output analogs signals S₁ and S₂.

The relative amount of fluorescence detected during the two periods of illumination depends upon the ratio of the lifetime τ and the switching period T. The quantity (S₁+S₂) represents the total detected fluorescence, whereas (S₁−S₂) represents the difference between the fluorescence intensities during the periods of high and low excitation intensity. The quantity (S₁−S₂)/(S₁+S₂) is independent of fluorescence intensity and is related in the case of a single exponential decay to the fluorescence lifetime τ of the fluorophore by the equation:

$$\frac{{S}_{1} - {S}_{2}}{{S}_{1} + {S}_{2}} = 1 - \frac{4 τ}{T} tanh ( \frac{T}{4 τ} )$$

By selecting an appropriate value for the switching period T, the above function may be made linear in τ/T, allowing the fluorescence lifetime τ to be readily determined.

In practice, the specimen may include two or more fluorophores, with different fluorescence lifetimes. These lifetime components can be extracted by using different detector switching periods. In this approach, which is illustrated in FIG. 4, the emitted light is detected first using a detector switching period equal to the period T of the excitation light, and second using a detector switching frequency that is a harmonic of the excitation frequency. The detector switching frequency may for example be three times the excitation frequency, so that the detector switching period is equal to T/3. This produces two pairs of values for the outputs signals S₁ and S₂ and therefore two values, which could be used to determine the fluorescence lifetime τ. Providing that the lifetimes of the fluorophores are sufficiently different, this provides a reasonably accurate estimate of the fluorescence lifetimes of the fluorophores.

If the sample contains more than two fluorophores, the different fluorescence lifetimes can be extracted by repeating the detection process an appropriate number of times at different switching frequencies, providing that the fluorescence lifetimes of the fluorophores are sufficiently well spaced from one another.

Alternatively, or in addition, the switching frequency of the excitation light maybe altered, to excite the different fluorophores at frequencies appropriate to their fluorescence lifetimes.

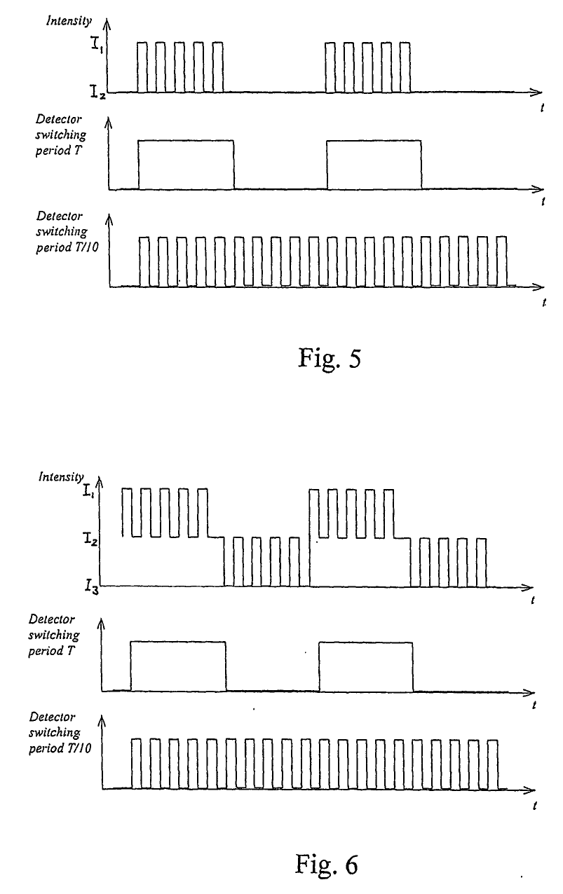

In an alternative approach, the excitation light can be modulated to include a combination of frequencies. For example, as shown in FIG. 5, the intensity of the excitation light can include a first component with a period T and second component with a period T/10. This results in a waveform having a first and second parts, each of duration T/2. The first part comprises a square wave with a period T/10 in which the intensity varies between I₁ and I₂, and in the second part the intensity is equal to a constant value I₂ (which may be zero). The detector is switched first with a period equal to T and second with a period equal to T/10, to provide two pairs of values for the outputs signals S₁ and S₂, from which the fluorescence lifetimes of the fluorophores can be determined.

Yet another option involves switching the excitation light between three or more levels, for example as shown in FIG. 6. In this example, the first part of the excitation waveform is a square wave having a period of T/10 that varies between a first intensity level I₁ and a second intensity level I₂, and the second part of the waveform comprises a square wave that varies between the second intensity level I₂ and the third intensity level I₃ (which may be zero). The detector switching periods are again equal to T and T/10 respectively. This method also permits lifetimes corresponding to T and T/10 to be measured.

Various other modifications of the approach are of course possible. These may include, for example, using different waveforms and introducing a delay between the switching periods of the excitation light and the detector. Instead of switching the output of the detector physically to provide the two output signals Y₁(t) and Y₂(t), the output signal can be divided electronically, for example using a computer, which can then integrate the two portions of the output signal over time to provide the two values S₁ and S₂ that represent the amount of light detected in each part of the cycle.

The system described above may be adapted for use in a parallelised system for measuring the fluorescence lifetime properties of several specimens simultaneously, for example for conducting a fluorescence assay. An example of such a system is shown schematically in FIG. 7. In this system, the signal generator 24 is connected to either a light source 4 or modulator 22, which has multiplexing optics 32 for supplying excitation light to a plurality of specimens 34. A bank of photodetectors 36 is arranged to detect emitted light from the samples 34, and is connected in parallel to a bank 38 of electronic switching units, which also receives a control signal from the signal generator 24. Each of these switching units includes a pair of outputs 40, allowing the fluorescence lifetimes of the respective samples 34 to be determined simultaneously.

The switching frequencies of the light source and the photodetector depend on the lifetimes of the fluorophores that are to be detected. For example, many biologically relevant fluorophores have lifetimes in the range of 1-10 ns. These include the visible fluorescent proteins (e.g. green fluorescent proteins or GFPs). GFPs normally have lifetimes around 3 ns. Rhodamine 6G has a lifetime of approximately 4 ns. DAPI is frequently used to label DNA and has two lifetime components that can vary between 0.4 and 3.9 ns, depending upon the nature of the DNA to which it is attached. This would be the primary range of application for this invention, and for measuring such lifetimes switching frequencies in the range approximately 10-100 MHz are appropriate.

Shorter fluorescence lifetime components of the order 10-100 ps are also present in many substances. For such lifetimes, switching frequencies up to 1000 MHz or even higher are appropriate. Longer lifetime fluorophores also exist (e.g. metal ligand complexes, which have lifetimes in the range of 100 ns-1 μs). These also fall within the capabilities of the present invention, as would any forms of luminescence with longer time scales. In these cases, switching frequencies of about 1-10 MHz or even lower may be appropriate.

The present invention also provides a method and a system for identifying labelled objects, by detecting the fluorescence lifetimes of fluorescent materials contained in labels carried by the objects. This is very useful as a security measure, for example to prevent forgery of valuable or important documents and other objects, such as banknotes, passports, identity cards and so on.

It is already known that fluorescent materials can be used to label objects, and that those objects can be identified by illuminating the labels to cause fluorescence, and measuring the wavelength and intensity of the emitted radiation. Such a method is described, for example, by Shoude Chang, Ming Zhou and Chander P. Grover in “Information coding and retrieving using fluorescent semiconductor nanocrystals for object identification”, Optics Express 143, Vol. 12, No. 1 (12 Jan. 2004), the content of which is incorporated herein by reference.

Briefly, the method described in that paper includes marking the objects with semiconductor nanocrystals (“quantum dots”) that contain one or more fluorescent materials, wherein the combination of spectral features (i.e. wavelength and intensity) of those materials provides a “signature” containing coding information that identifies each of the object. To check the identity of an object, this information is retrieved using a fluorospectrometer and the emission from each species is separated into different wavelength windows using appropriate wavelength filters. A deconvolution-based algorithm is used to separate any overlapping spectral profiles. By measuring the relative proportions of the different fluorescent species and comparing this information with a database of label signatures, the object can be identified.

In an embodiment of the present invention, a similar method to that described in the above-mentioned paper is used, except that the fluorescence lifetimes of the fluorescent materials contained in labels are used to identify the object, either alone or in combination with one or both of the other spectral features (the wavelength and intensity). This provides a useful extension to the previously proposed method, allowing more information to be encoded and/or allowing the reliance on intensity measurements (which may be unreliable) to be discarded.

The fluorescence lifetimes are preferably measured using the methods described in detail above, in which the intensity of the excitation light is switched repeatedly between two different intensity values, the detected light signal is switched and divided into portions, and the amount of light detected during each of those portions is measured to determine the fluorescence lifetimes of the fluorescent materials. This allows the method to be implemented using an inexpensive fluorescence lifetime measuring system. However, other methods for measuring fluorescence lifetimes may also be used.

In a simple form of the invention, the object is labelled with an ink that contains two fluorescent species, preferably contained in appropriately optimised quantum dots. The fluorophores are preferably chosen to have distinct fluorescent lifetimes: for example, if one species has the lifetime τ the other may typically have the lifetime 10 τ. A large separation in lifetimes makes it easier to separate the effects of the two species. The ink is excited from a suitable source, such as an LED or diode laser, which is switched in an appropriate manner, for example as described above. The emitted light is detected and the relative proportions and/or the fluorescence lifetimes of the two species are then derived from the detected signals.

This method of detection does not require spectral separation of the fluorophores and hence the emission spectra of the fluorophores may overlap. This is advantageous in a security marking situation, because it may not be obvious from the steady state spectrum that two species are present: this information only becomes apparent if the lifetime characteristics of the fluorophores are measured.

The system for identifying labelled objects may for example be broadly similar to the system shown in FIGS. 1 and 2, including an optical testing station 2 (which may include a confocal microscope, but which will generally use simpler optical apparatus), that includes a light source 4, a set of wavelength filters 8, an objective lens 12 for focusing light from the light source 4 onto a specimen 14, and a photodetector 16.

The system also includes an electronic control unit 18, which is connected to a computer 20. The control unit 18 is connected to the photodetector 16 and transmits output signals from the photodetector to the computer 20 for recording and analysis. The control unit 18 is also connected to the light source 4 to control operation of the light source. Alternatively, the control unit 18 may be connected to a modulator 22 located in front of the light source 4, for modulating the intensity of the excitation light.

Each object to be identified by the system carries a label, for example in the form of a quantum dot, containing a combination of fluorescent materials having fluorescent characteristics that together form a “signature”, which identifies the object. A list of these signatures and the objects marked with the signatures is stored in a database held within the computer 20. The system is operated substantially as described previously to measure the fluorescence characteristics of the fluorophores contained within the label. These

characteristics will include the fluorescent lifetime of the materials, and if required the emission wavelengths and the intensity of the emitted light may also be measured. This information is used to compile the fluorescent signature of the label. The compiled signature is then compared with the database of signatures stored in the database to identify the object.

Various modifications of this method and system are possible. For example, more than two fluorophores with different lifetimes can be incorporated into the ink and the detection system can be configured appropriately to detect those fluorophores, for example by combining several different switching frequencies. The measurement of fluorescence lifetime can also be combined with spectral separation, allowing the lifetime measurements to be performed simultaneously in different spectral windows. The spectral components would be separated into different channels using wavelength specific filters and a switched fluorescent lifetime detection system would be incorporated into each spectral channel. Alternatively, different excitation wavelengths from a number of light sources can be used to excite the various fluorophores. The light sources could be switched at different frequencies or using different schemes.

1. A method of measuring fluorescence lifetime, the method including:
illuminating a sample containing at least one fluorophore with light to excite fluorescence;
switching the intensity of the excitation light repeatedly between a first intensity I₁ and a second intensity I₂;
detecting emitted light caused by fluorescence of the sample thereby generating a detected light signal;
repeatedly switching the detected light signal to divide it into first and second portions;
measuring the amount of light detected during each of said first and second portions to obtain a first emitted light value S₁ and a second emitted light value S₂; and
determining the fluorescence lifetime from the first and second emitted light values S₁ and S₂.

2. A method according to claim 1, wherein the excitation light is switched at a first frequency F₁ and the detected light signal is switched at a second frequency F_{D}, wherein F_{D} is related to F₁.

3. A method according to claim 2, wherein F_{D} is synchronized with F₁.

4. A method according to claim 2, wherein F_{D} equals F₁.

5. A method according to claim 2, wherein F_{D} is a harmonic of F₁.

6. A method according to claim 1, wherein the excitation light is switched at a frequency of 1-1000 MHz.

7. A method according to claim 1, wherein the detected light signal is switched at a first frequency F_{D} to obtain a first set of emitted light values S₁ and S₂ from which a first fluorescence lifetime is determined, and the detected light signal is then switched at a second frequency F_{D}′ to obtain a second set of emitted light values S₁′ and S₂′, from which a second fluorescence lifetime is determined.

8. A method according to claim 7, wherein F_{D} and F_{D}′ are different harmonics of the excitation light switching frequency F₁.

9. A method according to claim 7, wherein the excitation light is switched according to a switching function that includes a plurality of components of different frequencies.

10. A method according to claim 9, wherein the switching function of the excitation light includes a first component F₁ and a second component F₁′ that is a harmonic of F₁.

11. A method according to claim 7, wherein the intensity of the excitation light is switched repeatedly between a first intensity I₁, a second intensity I₂ and a third intensity I_{3.}

12. A method according to claim 11, wherein the third intensity I₃ is substantially zero.

13. An apparatus for measuring the fluorescence lifetime of a sample containing at least one fluorophore, the apparatus including:
a light source for illuminating the sample to excite fluorescence;
first switching means for switching the intensity of the excitation light repeatedly between a first intensity I₁ and a second intensity I₂;
a detector for detecting emitted light caused by fluorescence of the sample thereby generating a detected light signal;
second switching means for dividing the detected light signal into first and second portions;
means for measuring the amount of light detected during said first and second portions to obtain a first emitted light value S₁ and a second emitted light value S₂; and
means for determining the fluorescence lifetime from the first and second emitted light values S₁ and S₂.

14. An apparatus according to claim 13, further comprising control means for controlling switching of the first switching means and the second switching means.

15. An apparatus according to claim 13, wherein the first switching means is connected to a modulator device for controlling the intensity of the light generated by the light source.

16. An apparatus according to claim 13, wherein the first switching means is connected to a modulator device for controlling the intensity of the excitation light incident on the sample.

17. An apparatus according to claim 16, wherein the modulator device comprises an electro-optical scanner.

18. An apparatus according to any claim 13, wherein the light source is a diode laser.

19. An apparatus according to claim 13, wherein the light source comprises one or more LEDs.

20. An apparatus according to claim 13, wherein the apparatus is part of a microscopic imaging system.

21. An apparatus according to claim 20, wherein the microscopic imaging system includes a confocal scanning microscope.

22. An apparatus according to claim 13, wherein the apparatus is part of a fluorescence assay system.

23. An apparatus according to claim 22, wherein the fluorescence assay system includes a plurality of sample holders, and wherein the apparatus includes a plurality of detectors and means for measuring the lifetimes of samples in the sample holders substantially simultaneously.

24. (canceled)

25. a method of identifying labeled objects, wherein each object carries a label that contains a combination of fluorescent materials, the method including:
illuminating the label to excite fluorescence;
detecting emitted light caused by fluorescence of the fluorescent materials;
measuring the fluorescence lifetimes of the fluorescent materials;
identifying the combination of fluorescent materials present in the label from the fluorescence lifetimes; and
identifying the object from that combination.

26. (canceled)

27. A method according to claim 25 wherein the method further comprises measuring the wavelengths of the emitted light, and identifying the combination of fluorescent materials present in the label from the wavelengths and the fluorescence lifetimes.

28. A method according to claim 27, wherein the method further comprises measuring the intensity of the emitted light and identifying the combination of fluorescent materials present in the label from the wavelengths, the intensity and the fluorescence lifetimes.

29. A method according to claim 25, wherein the label comprises an ink marking applied to the object, said ink including a combination of fluorescent materials.

30. A system for identifying labeled objects, wherein each object carries a label that contains a combination of fluorescent materials and said combination identifies the object, the system including:
A light source for illuminating the label to excite fluorescence;
A detector for detecting emitted light caused by fluorescence of the fluorescent materials;
Means for measuring the fluorescence lifetimes of the fluorescent materials; and
A processor for identifying from the measured fluorescent lifetimes the combination of fluorescent materials present in the label, and for identifying the object from that combination.

31. (canceled)

32. The method of claim 6, wherein the excitation light is switched at a frequency of 10-100 MHz.
